(19) United States
(12) Patent Application Publication
(10) Pub. No.: US 2003/0001736 A1
(43) Pub. Date: Jan. 2, 2003

(54) Service set-point device

(76) Inventor: Jeffrey Lewis, Mountain View, CA (US)

Correspondence Address: JEFFREY LEWIS, 1970 LATHAM ST #2, MOUNTAIN VIEW, CA, 94040, US

(21) Appl. No.: 10/170,068

(22) Filed: Jun. 13, 2002

Related U.S. Application Data
(60) Provisional application No. 60/297,625, filed on Jun. 13, 2001.

(51) Int. Cl. B60Q 1/00

(52) U.S. Cl. 340/457; 701/29; 701/30; 340/531

(57) ABSTRACT

This application describes a method and system for transmitting information from a vehicle, machine or equipment in order to conduct its prescribed maintenance. The method sources the data from either of distance traveled, hours operated or its condition. The typical maintenance is defined by preventive or condition monitoring or service activities. The system generates the appropriate signal to deliver, via wireless, the signal to alert or alarm that the critical set point measurement is arrived at, or exceeded. This signal informs by email and further selects the elements of maintenance activities from an electronic database and forwards it to conduct the said service activities.

### CROSS-REFERENCE TO RELATED APPLICATION

This is a formalization of provisional application No. 60/297,625, filed Jun. 13, 2001, which are incorporated herein by reference in its entirety, priority and the benefit of the filing date of which is hereby claimed.

Inventor: Lewis, Jeffrey 1970 Latham Street #2 Mountain View, Calif. 94040 References Cited U.S. PATENT DOCUMENTS Provisional ##60/297,625 Application References

U.S. Pat. Documents

| | | | |
|---|---|---|---|
| 6181994 | Jan., 2001 | Colson et al | 701/33 |
| 5442553 | August 1995 | Parrillo | 455/420. |
| 5732074 | March 1998 | Spaur et al. | 370/313. |
| 5758300 | May 1998 | Abe | 455/456. |
| 5781871 | July 1998 | Mezger et al. | 455/456. |
| 5922037 | July 1999 | Potts | 701/29. |
| 6025776 | February 2000 | Matsuura | 340/438. |
| 6032089 | February 2000 | Buckley | 701/36. |

Foreign Patent Documents

| | | |
|---|---|---|
| 0 685 723 A2 | December 1995 | EP. |
| 10-194095 | July 1998 | JP. |

### BACKGROUND OF THE INVENTION

1. Field of the Invention

This invention relates to a device, which has programmable set points for a vehicle/equipment signal, generated by the operational time, distance or condition parameters, in order to transmit when the set-point measurements are reached. The measurement is transmitted by wireless to inform by email: that the multi set-points are reached and provides the predetermined documented maintenance/service activities required as at the set point.

2. Description of Related Art

When a vehicle or equipment is operating, service becomes due based on time, distance or condition and there is a requirement for prescribed maintenance. When it is operated intermittently, if the equipment is not in a fixed location, management may not be aware that the period is reached apart from repeated manual checks. Thus the device being invented triggers an alert as the set point is reached and sends a message by wireless to avoid the repeated manual checks to determine when the service requirements are due. The ability to be alerted when the set point is reached makes the management of maintenance more proactive and allows for planning the activities, (availability of service resources) when dealing with off-site (as in the case of equipment rentals) or non-stationary situations.

Managers of equipment have extreme difficulty in tracking the distance, time or condition, when maintenance is due. In owner-operated vehicles, a sticker is placed on the glass to inform the user that service is due. In other cases a warning light comes on to advise that engine service is required. However there are circumstances, which mitigate against these being an effective method and relate to off-site or remote conditions. Examples of these situations are as follows:

1. ‘Engine service’ does not defined the other activities that need to be attended to on the vehicle. e.g transmission oil change, and other checks or monitoring requirements, which may have other predetermined timeframes.

2. Engine (Diesel/IC) driven equipment (compressors, cranes, rigs), which is rented out cannot inform the ‘rentor’ in a timely fashion when the scheduled service is due, as measured by hours, distance or condition.

3. Tractor Engine rigs driven across country far away from the owners, who are unaware when the service period has been reached.

4. The service schedule usually consists of several activities. These take place as per parameters of time, condition or distance. The list of activities is usually not available on the occasion when the prescribed parameters are reached if away from the home base.

The present invention allows a signal to be generated for equipment/machinery/vehicle critical set points for any of the following:

the length of time for operations

distance traveled

its condition status

The device allows the transmission of a measurement signal wirelessly, in order to inform the assigned responsible person, that the prescribed maintenance has become due. When the set point is approached, reached or exceeded, the device enables access via its wireless capability, to the database of service activities for selecting the predetermined activities, for forwarding by email.

E.g At 250 running hours a crane may require the monitoring of cables, at 3000 miles a compressor may require a filter change, a portable compressor may have an oil change condition signal, like a flashing light. When such equipment is out in the field, those responsible for the maintenance may not know when these parameters are reached. They may not have the list of activities at hand. A generated signal, which is informed when these are reached and has the capability to send wirelessly, provides an advantage for the useful management of resources and assurances that the maintenance is timely indicated.

Thus, a new generation of network communications can alert owners and managers of the equipment maintenance requirements. The alert is based on the prescribed intervals of time, distance or condition via cellular telephone, wireless communications and Internet access via a wireless communication link. This provides a rich networking topology that allows those responsible for managing the maintenance, to keep abreast of the timeliness of execution, since the equipment may not within their direct immediate control, when the time, distanced traveled or required condition status is arrived at. E.g Portable compressors leased or rented, away from its base location, This leads to enhanced longevity of equipment due to timely maintenance.

### SUMMARY OF THE INVENTION

The present invention involves the ability to transmit information from equipment to the responsible person, delivered via wireless, that maintenance is due based on its time, distance or condition is reached. The invention consists of: A device which has the capability to program the equipment identification, have multi set points, and the means to trigger a signal when the programmed set point is reached.

The programmable set point IC and measuring IC make up a full operational component with the wireless modem. As a component it is mounted on the unit to interact with the network, either by WAN, LAN or wireless network communication techniques. This can be accomplished by linking the said measuring IC/modem combination to provide the signal for the wireless technology for sending the email or alert by any other means for service information from the maintenance database.

### BRIEF DESCRIPTION OF THE DRAWING

The present invention will be better understood and its numerous objects and advantages will become more apparent to those skilled in the art by reference to the following drawing, in conjunction with the accompanying functional specification, in which:

FIG. 1 is provided for purposes of general background and represents a flowchart for the process of the present invention:

The drawing shows the link from the Controller Area Network (CAN) where all signals from engine driven equipment monitors/controls the operations. The signal from the CAN may be triggered from the CAN via a CANPORT adaptor to meet the SERVICE SET-POINT DEVICE. The Service Set-Point device, when the various set-points are arrived at, links to the wireless portion of the invention and sends a signal to the database to inform via email and to send the service maintenance activities.

### DETAILED DESCRIPTION OF THE INVENTION

At this point it would be appropriate and helpful to review the topic of wireless networks to better understand the present invention. In wireless network communications, data is carried over radio waves or by means of infrared light. There are a plethora of standards built around IEEE 802.11 standards and TCP/IP protocol.

A wireless LANs similar to cellular networks will be used with several wireless access points connected to a standard Ethernet.

Out-of-office networking technology, as represented by radio modems, is quite amenable for use in the present invention. It is referred to as cellular digital packet data (CDPD), which enables a user to send data packets using a cellular network, similar to what is used for cellular telephones.

The present invention provides the ability to deliver time, distance, or condition-based information from equipment at the pre set points via wireless network.

Thus, a new generation of network unit communications with cellular telephone, wireless communications and Internet access, via wireless communication link provides the information alert for due maintenance.

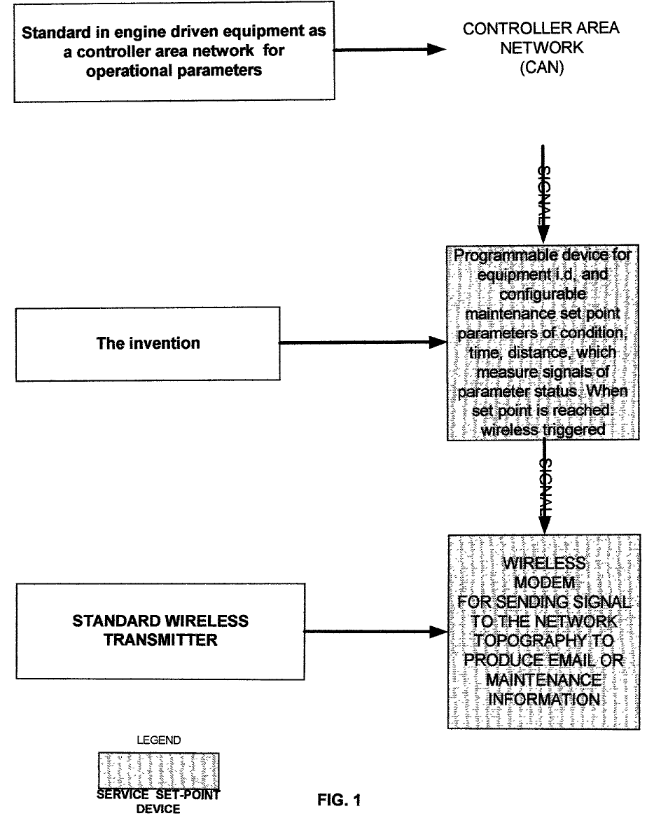

FIG. 1 is provided merely for purposes of general background. It represents a typical block diagram of a data processing system including a PLC timer unit and network connections via a communications adapter, which is capable of implementing the present invention.

A central processing unit (CPU), such as one of the PowerPC microprocessors available is used for programming the set points based and identification to inform which unit delivers the alert parameters for maintenance. The appropriate software will facilitate the set point setting.

The device is hooked up to the equipment for two reasons:

1. To provide a power source

2. To draw a signal from the CAN when the vehicle is in operation to determine the operating time, distance or engine condition of equipment/vehicle.

2.1 The operating time as per the timer, is matched against the set points and at these points an electronic signal is triggered.

2.2 The mileage as per the odometer is matched against the set points and at the predetermined points a signal is triggered.

2.3 The condition is matched against the on board condition system, for the condition signal.

The signal is sent to the wireless modem, which sends a signal to the telecommunications network, for sending e-mail to the maintenance management that the particular set point has been reached for the required maintenance activities.

While the invention has been shown and described with reference to particular embodiments thereof, it will be understood by those skilled in the art that the foregoing and other changes in form and detail may be made therein without departing from the spirit and scope of the invention.

The invention claims are as follows:

1. A method for setting predetermined critical values (set point) when they are reached for maintenance activities, and providing the wireless transmission from the equipment/vehicle/machinery for executing the required prescribed activities. The measurement values are based either on time, distance or the condition of the equipment.

2. The method of claim 1 wherein transmitting from said vehicle/machinery or equipment is accomplished via a wireless communication means.

3. The method of claim 1 further comprising the steps of:
providing an IC programmable measuring device to determine the set point (of distance, time or condition) of the prescribed service and an IC programmable device which determines that the proximity to the set point prior to the set value, the set value and exceeded value.

3. The system to collect and execute the appropriate measuring parameters and signals for comparison, along with the appropriate power devices

4. The signal transmission device for connection from the equipment via a wireless modem to a network topology to the person responsible for servicing the vehicle.

6. A programmable chip that allows the intended user to input a unique identification number to identify the individual piece of equipment
